(19) United States
(12) Patent Application Publication
(10) Pub. No.: US 2026/0116169 A1
(43) Pub. Date: Apr. 30, 2026

(54) VEHICLE LOWER STRUCTURE

(71) Applicant: HONDA MOTOR CO., LTD., Tokyo (JP)

(72) Inventors: Yuki MATSUSHIMA, Tokyo (JP); Shinya NAKAYAMA, Tokyo (JP)

(73) Assignee: HONDA MOTOR CO., LTD., Tokyo (JP)

(21) Appl. No.: 19/366,020

(22) Filed: Oct. 22, 2025

(30) Foreign Application Priority Data
Oct. 25, 2024 (JP) 2024-188076

(51) Int. Cl. B60K 1/04; B60L 50/64; B62D 21/02; B62D 21/15; H01M 50/242; H01M 50/249

(52) U.S. Cl. CPC B60K 1/04; B60L 50/64; B62D 21/02; B62D 21/15; H01M 50/242; H01M 50/249; B60K 2001/0438; H01M 2220/20

(57) ABSTRACT

A vehicle lower structure includes: a vehicle body; and a battery pack attached to a lower portion of the vehicle body, the battery pack includes a battery case, a battery accommodated in the battery case, and a component accommodated in the battery case and disposed between a pair of left and right cross members extending in a vehicle width direction, at least a part of the component overlaps the cross members when viewed in the vehicle width direction, and the battery pack further includes a protective member, a part of which is disposed between the left cross member and the component and another part of which is disposed between the right cross member and the component in the vehicle width direction.

### CROSS-REFERENCE TO RELATED APPLICATION

This application is based on and claims priority under 35 USC 119 from Japanese Patent Application No. 2024-188076 on Oct. 25, 2024.

### TECHNICAL FIELD

The present invention relates to a vehicle lower structure.

### BACKGROUND ART

In recent years, researches and developments have been conducted on a secondary battery which contributes to improvement in energy efficiency in order to allow more people to have access to affordable, reliable, sustainable and advanced energy.

In a vehicle where a secondary battery is attached to a vehicle body as a battery pack, researches and developments on vehicle collision safety performance have been intensively conducted. For example, Patent Literature 1 and Patent Literature 2 disclose a structure for protecting a battery module, an auxiliary device, and a high voltage wire disposed in a battery pack from a side collision load received due to a vehicle side collision.
Patent Literature 1: JP2017-196942A
Patent Literature 2: JP2022-083731A

### SUMMARY OF INVENTION

Depending on attachment of the battery pack to the vehicle body, it is conceivable that a cross member may overlap a component in the battery pack when viewed in a vehicle width direction. In such a case, it is required to consider a structure that can appropriately protect the component in the battery pack from a collision load transmitted from the cross member due to a vehicle side collision.

The present invention provides a vehicle lower structure that can appropriately protect a component disposed in a battery pack against a load received from the outside.

An aspect of the present invention provides
a vehicle lower structure including:
   a vehicle body; and
   a battery pack attached to a lower portion of the vehicle body, in which
   the battery pack includes
      a battery case,
      a battery accommodated in the battery case, and
      a predetermined component accommodated in the battery case and disposed between a pair of left and right cross members extending in a vehicle width direction,
   at least a part of the predetermined component overlaps the cross members when viewed in the vehicle width direction, and
   the battery pack further includes a protective member disposed between the cross members and the predetermined component in the vehicle width direction.

According to the aspect of the present invention, since the protective member is disposed between the cross members and the predetermined component, when a collision load is received by the cross members due to a vehicle side collision or the like, the protective member can receive the collision load and the predetermined component can be appropriately protected.

### BRIEF DESCRIPTION OF DRAWINGS

FIG. 1 is a perspective view of a vehicle lower structure according to an embodiment of the present invention.

FIG. 2 is a perspective view of a battery pack 10.

FIG. 3 is an exploded perspective view of the battery pack 10.

FIG. 4 is a cross-sectional view taken along line A-A in FIG. 1.

FIG. 5 is a cross-sectional view taken along line B-B in FIG. 1.

FIG. 6 is an enlarged cross-sectional view of a protective member 30 in FIG. 5.

### DESCRIPTION OF EMBODIMENTS

Hereinafter, an embodiment of a vehicle lower structure according to the present invention will be described with reference to the accompanying drawings. The drawings are viewed in directions of reference numerals. In the present specification and the like, in order to simplify and clarify the description, a front-rear direction, a left-right direction, and an upper-lower direction are described according to directions viewed from a driver of a vehicle, and in the drawings, a front side of the vehicle is shown as Fr, a rear side is shown as Rr, a left side is shown as L, a right side is shown as R, an upper side is shown as U, and a lower side is shown as D.

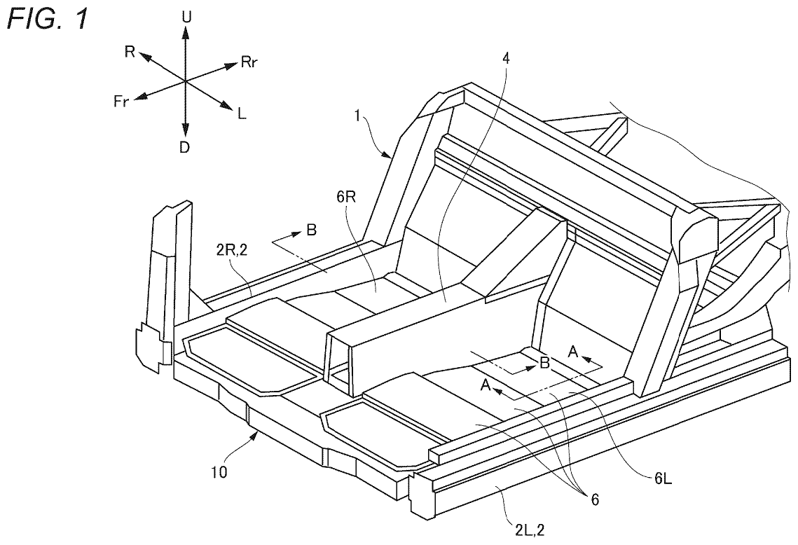

FIG. 1 is a perspective view of the vehicle lower structure. The vehicle lower structure includes a vehicle body 1 and a battery pack 10 attached to a lower portion of the vehicle body 1. The vehicle is, for example, an electric vehicle such as a battery electric automobile, a hybrid vehicle (including a plug-in hybrid vehicle), or a fuel cell vehicle. The battery pack 10 stores electric power to be supplied to a motor or the like serving as a drive source of the vehicle.

A vehicle body 1 constitutes a framework of the vehicle, and FIG. 1 illustrates a part of the framework. The vehicle body 1 includes, for example, a pair of left and right side sills 2 (2L and 2R) extending in the front-rear direction, a center tunnel 4 provided between the pair of left and right side sills 2 and extending in the front-rear direction, and a plurality of cross members 6 provided between the pair of left and right side sills 2 and extending in the left-right direction. Each cross member 6 includes a pair of left and right cross members 6L and 6R provided on both left and right sides of the center tunnel 4. The left cross member 6L is provided between the left side sill 2L and the center tunnel 4, and the right cross member 6R is provided between the right side sill 2R and the center tunnel 4.

The battery pack 10 is disposed below the plurality of cross members 6. The battery pack 10 is attached to the pair of left and right side sills 2 and fixed by a fastening member such as a bolt.

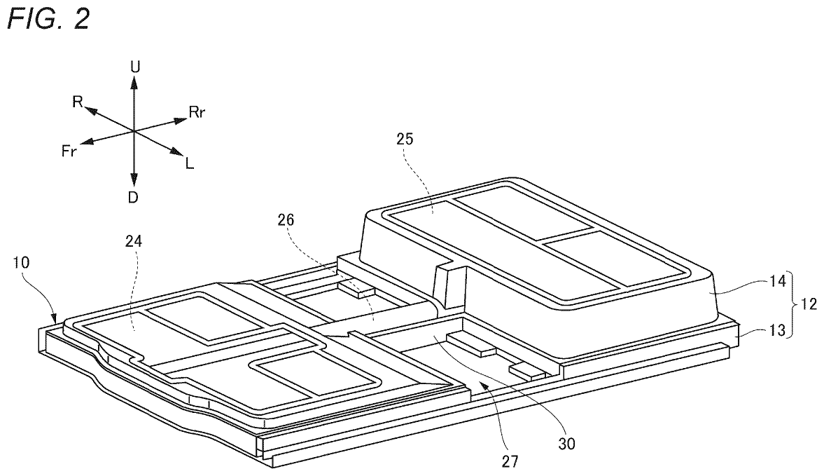

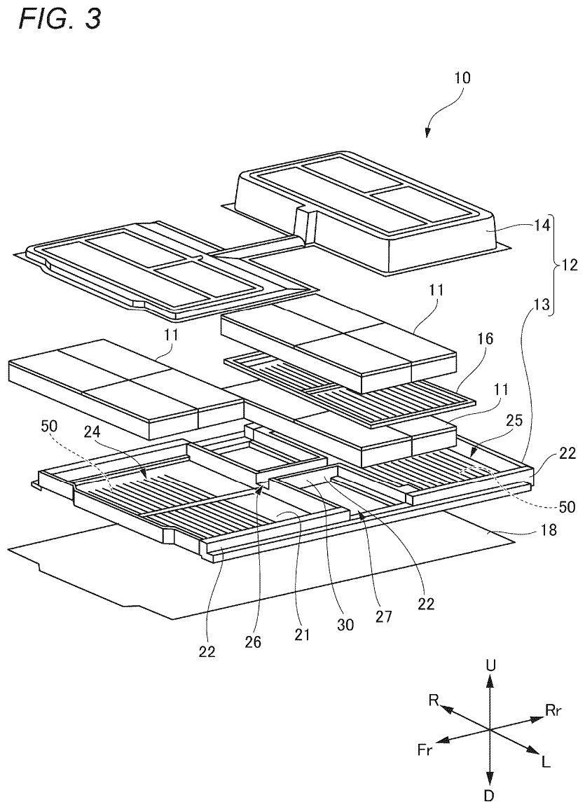

FIG. 2 is a perspective view of the battery pack 10. FIG. 3 is an exploded perspective view of the battery pack 10. The battery pack 10 includes a battery 11, a battery case 12 that accommodates the battery 11, and an under cover 18 that is formed of a heat insulating material such as foamed polypropylene and covers the battery case 12 from below.

A plurality of batteries 11 are accommodated in the battery case 12. Each battery 11 is, for example, a lithium ion battery or a nickel-metal hydride battery. Each battery 11 includes a plurality of battery cells. Although not illustrated, each battery cell includes a positive electrode, a negative electrode, an electrolyte, and an exterior body that accommodates these components, and is, for example, a pouch-type cell, a prismatic cell, or a cylindrical cell. The electrolyte may be a liquid or a solid. The battery 11 may be implemented as a battery module where the plurality of battery cells (for example, pouch-type cells or prismatic cells) are stacked and modularized, or may be implemented as a plurality of battery cells that are not modularized.

The battery case 12 includes a case body 13 where the battery 11 is placed, and a battery cover 14 that covers the case body 13 from above.

The case body 13 includes a base plate 21 where the battery 11 is placed, and a frame member 22 joined to the base plate 21. The case body 13 has a tray shape that can accommodate the battery 11.

The base plate 21 has a substantially rectangular shape in a top view. The base plate 21 is formed by pressing a metal material. The metal material of the base plate 21 is, for example, aluminum or an aluminum alloy, which allows a weight of the battery case 12 to be reduced. The base plate 21 may also be made of iron.

A water jacket 50 is provided at a lower portion of the base plate 21, and a temperature of the battery 11 is adjusted (reduced or increased) by a coolant flowing through the water jacket 50. The under cover 18 covers the water jacket 50 from below.

The frame member 22 is produced by performing extrusion molding on a metal material. The frame member 22 is, for example, an aluminum extruded material produced by performing extrusion molding on aluminum or an aluminum alloy. Since the frame member 22 is made of the aluminum extruded material, the frame member 22 has a high rigidity and a light weight. The frame member 22 is joined to an upper surface of the base plate 21 by welding or the like, and constitutes a side wall of the case body 13.

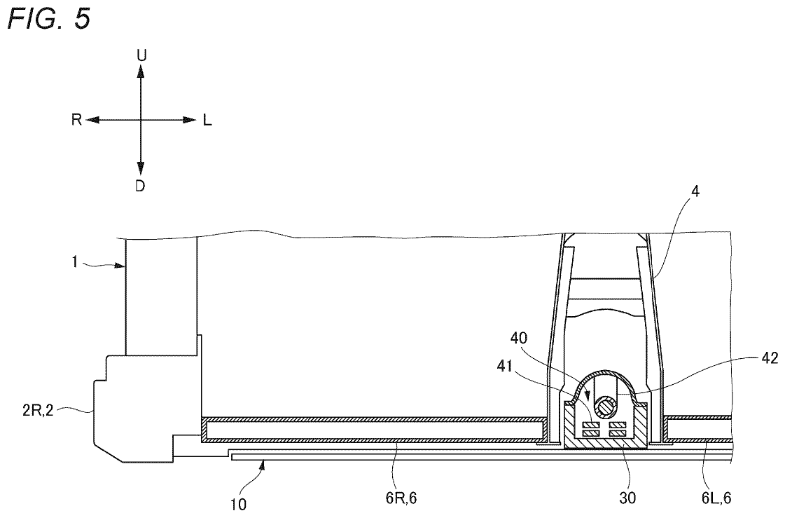

The case body 13 includes a front-side accommodation space 24 that is provided on a front side to accommodate the battery 11, a rear-side accommodation space 25 that is provided on a rear side to accommodate the battery 11, and an arrangement space 26 which is provided between the front-side accommodation space 24 and the rear-side accommodation space 25 and in which a bus bar 41, a harness 42, and the like (see FIG. 5) are arranged. In the following description, a component arranged in the arrangement space 26 is also referred to as an arranged component 40. The front-side accommodation space 24, the rear-side accommodation space 25, and the arrangement space 26 are defined and formed by the frame member 22.

The front-side accommodation space 24 and the rear-side accommodation space 25 are each defined and formed by the frame member 22 in a substantially rectangular shape in a top view. In the front-side accommodation space 24, the batteries 11 are accommodated in one tier. The batteries 11 are accommodated in the rear-side accommodation space 25 via the bracket 16 in two upper and lower tiers. In addition to the batteries 11, for example, an electrical connection box where an electrical component (an input and output circuit, a fuse, or the like) to be connected to the batteries 11 is mounted, and a control device such as an electronic control unit (ECU) may be accommodated in the front-side accommodation space 24 and the rear-side accommodation space 25. In addition, the number of tiers in the upper-lower direction of the batteries 11 accommodated in the front-side accommodation space 24 and the rear-side accommodation space 25 can be set as desired, and for example, the batteries 11 may be accommodated in one tier in the rear-side accommodation space 25 or the batteries 11 may be accommodated in two tiers in the front-side accommodation space 24.

The arrangement space 26 extends in the front-rear direction in order to connect the front-side accommodation space 24 and the rear-side accommodation space 25 at a central portion of the case body 13 in a vehicle width direction. The arrangement space 26 is provided at a position overlapping the center tunnel 4 in a top view.

In the arrangement space 26, the arranged component 40 is disposed (arranged), such as the bus bar 41 that is a high voltage wire electrically connecting the battery 11 accommodated in the front-side accommodation space 24 and the battery 11 accommodated in the rear-side accommodation space 25, and the harness 42 connected to various electrical devices accommodated in the battery case 12. In addition to the bus bar 41 and the harness 42, the arranged component 40 may include a pipe, a hose, or the like which is connected to the water jacket 50 and through which the coolant flows, and is not limited to an electrical component.

In the arrangement space 26, components such as an electrical connection box and a control device may be disposed instead of the arranged component 40 arranged in the front-rear direction or in addition to the arranged component 40. That is, a predetermined component (the arranged component 40, the electrical connection box, the control device, or the like) is disposed in the arrangement space 26. Hereinafter, an example in which the predetermined component disposed in the arrangement space 26 is the arranged component 40 (specifically, the bus bar 41 and the harness 42) will be described.

A portion of the frame member 22 defining and forming the arrangement space 26 functions as a protective member 30 that protects the arranged component 40 from an impact from the outside. Details of the protective member 30 will be described later.

A cross member disposition space 27 where one cross member 6 (6L and 6R) among the plurality of cross members 6 is disposed is provided on both left and right sides of the arrangement space 26. When the battery pack 10 is attached to the vehicle body 1, the cross member 6 is disposed in the cross member disposition space 27. The cross member 6 is joined to the center tunnel 4. The battery pack 10 is fixed, by a fastening member such as a bolt, not only to the pair of left and right side sills 2 but also to the cross member 6 disposed in the cross member disposition space 27.

In a state where the battery pack 10 is attached to the vehicle body 1, the protective member 30 and the arranged component 40 overlap the cross member 6 when viewed in the vehicle width direction. According to such a configuration, a height dimension of the vehicle lower structure where the battery pack 10 is attached can be reduced, and as a result, an overall height of the vehicle can be reduced.

A seat (not illustrated) of the vehicle is mounted at an upper portion of the cross member 6 disposed in the cross member disposition space 27. Since the battery 11 is not disposed below the cross member 6, load transmission from the seat to the battery 11 can be prevented.

The battery cover 14 is fixed to an upper surface of the frame member 22 to seal the inside of the battery case 12. Specifically, the battery cover 14 has a shape along the upper surface of the frame member 22, which defines and forms the front-side accommodation space 24, the rear-side accommodation space 25, and the arrangement space 26, and covers these spaces from above. The battery cover 14 does not cover a portion where the cross member disposition space 27 is provided. That is, the battery cover 14 has a shape whose central portion in the front-rear direction is narrow in the vehicle width direction.

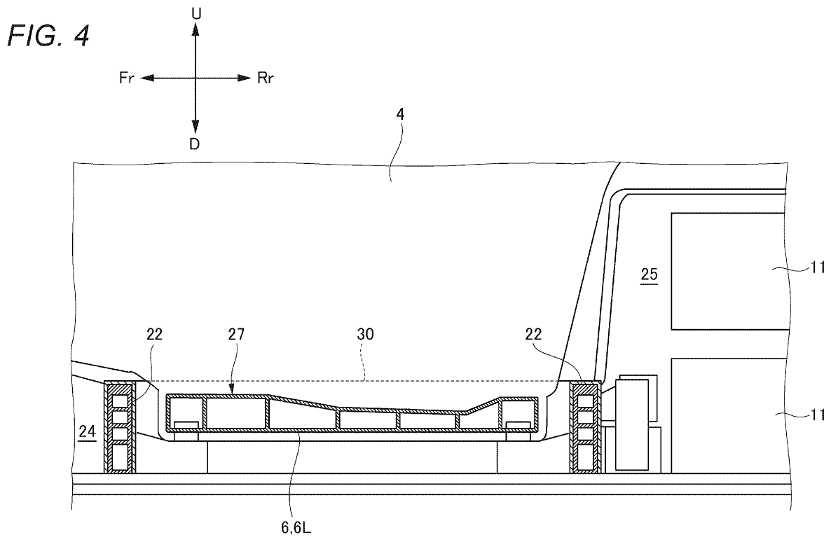

Next, a configuration of the protective member 30 that protects the arranged component 40 will be described in detail with reference to FIGS. 4 to 6.

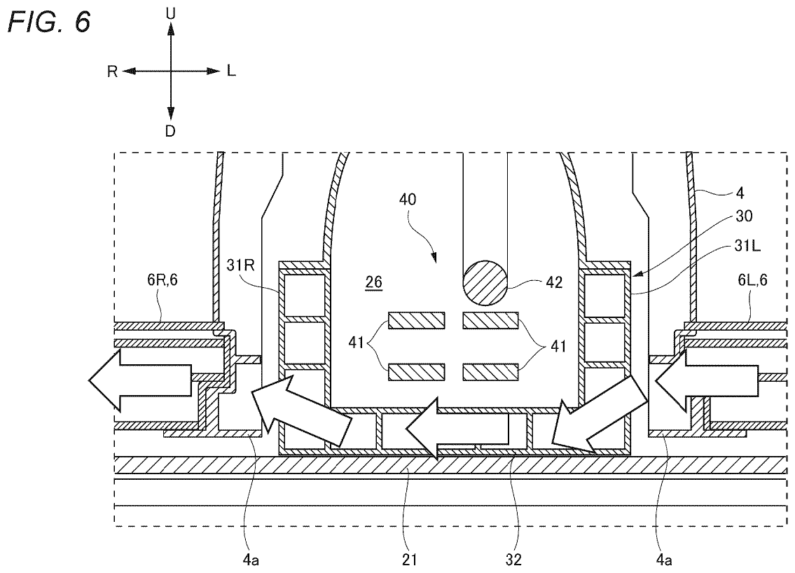

FIG. 4 is a cross-sectional view taken along line A-A in FIG. 1, and illustrates a disposition relationship among the cross member 6, the center tunnel 4, and the protective member 30 when viewed in the vehicle width direction. FIG. 5 is a cross-sectional view taken along line B-B in FIG. 1, and illustrates a disposition relationship among the cross member 6, the center tunnel 4, and the protective member 30 when viewed in the front-rear direction. FIG. 6 is an enlarged cross-sectional view of the vicinity of the protective member 30 in FIG. 5. A hollow arrow in FIG. 6 indicates transmission of a collision load received due to a vehicle side collision or the like.

The protective member 30 is disposed between the pair of left and right cross members 6L and 6R and the arranged component 40 in the vehicle width direction. Specifically, the protective member 30 is disposed between the left cross member 6L and the arranged component 40 and between the right cross member 6R and the arranged component 40 in the vehicle width direction. In other words, when viewed in the vehicle width direction, the pair of left and right cross members 6L and 6R, the protective member 30, and the arranged component 40 overlap each other.

According to such a configuration, when a collision load is input from the side sill 2 to the cross member 6 due to a vehicle side collision or the like, the collision load transmitted by the cross member 6 can be received by the protective member 30, and thus the arranged component 40 can be protected.

The center tunnel 4 covers the arranged component 40 and the protective member 30 from above, and at least a part thereof overlaps the cross members 6L and 6R when viewed in the vehicle width direction. More specifically, at least a part of the center tunnel 4 overlaps the cross members 6L and 6R and the protective member 30 when viewed in the vehicle width direction. In other words, at least a part of the center tunnel 4 is provided between the left cross member 6L and the protective member 30 and between the right cross member 6R and the protective member 30 in the vehicle width direction.

According to such a configuration, at the time of vehicle side collision, the collision load is received by the center tunnel 4 before the collision load transmitted by the cross member 6 is received by the protective member 30, and thus protection performance for the arranged component 40 can be improved.

The center tunnel 4 is provided with a deformable portion 4a that is more easily deformed than the protective member 30 when the collision load is received by the cross member 6. Specifically, the deformable portion 4a has a flat plate shape extending in a horizontal direction and is a portion that is easily crushed when colliding with the protective member 30 due to the collision load from a lateral side.

According to such a configuration, when the collision load is input from the cross member 6 to the center tunnel 4, the deformable portion 4a of the center tunnel 4 is deformed (specifically, crushed) to absorb the impact. Therefore, the protection performance for the arranged component 40 can be further improved.

The protective member 30 is spaced apart from the arranged component 40 in the vehicle width direction. That is, even when the collision load is applied to the protective member 30 in the vehicle width direction and a position of the protective member 30 in the vehicle width direction is displaced, the protective member 30 does not immediately collide with the arranged component 40.

According to such a configuration, when the collision load is transmitted from the cross member 6 to the protective member 30, an influence of the protective member 30 on the arranged component 40 can be reduced.

Here, to describe the structure of the protective member 30 in more detail, the protective member 30 includes a pair of left and right walls 31L and 31R disposed between the pair of left and right cross members 6L and 6R and the arranged component 40 in the vehicle width direction, and a coupling portion 32 coupling the pair of left and right walls 31L and 31R. The pair of left and right walls 31L and 31R extend in the upper-lower direction, and the coupling portion 32 extends in the horizontal direction. The pair of left and right walls 31L and 31R overlap the cross members 6L and 6R, the arranged component 40, and the center tunnel 4 when viewed in the vehicle width direction.

Since the protective member 30 includes the pair of left and right walls 31L and 31R and the coupling portion 32 coupling these walls, for example, when the left wall 31L receives a collision load transmitted from the left cross member 6L, the collision load can be transmitted to the right cross member 6R via the coupling portion 32. Therefore, the protection performance for the arranged component 40 can be improved.

In the present embodiment, the pair of left and right walls 31L and 31R and the coupling portion 32 define and form a space that is open upward (that is, the arrangement space 26), and the arranged component 40 is arranged in the space. Specifically, the coupling portion 32 is connected to lower ends of the pair of left and right walls 31L and 31R, and the protective member 30 has a substantially U shape whose cross section is open upward.

According to such a configuration, it is easy to arrange the arranged component 40 into the space defined and formed in the protective member 30, and thus assemblability of the battery pack 10 is improved.

The pair of left and right walls 31L and 31R and the coupling portion 32 may define and form a space that is open downward. Specifically, the coupling portion 32 may be disposed at upper ends of the pair of left and right walls 31L and 31R.

As a modification, the pair of left and right walls 31L and 31R and the coupling portion 32 may define and form a space constituting a closed cross section (that is, the arrangement space 26), and the arranged component 40 may be arranged in the space. In this configuration, a pair of upper and lower coupling portions 32 are provided, the upper coupling portion 32 is connected to the upper ends of the pair of left and right walls 31L and 31R, and the lower coupling portion 32 is connected to the lower ends of the pair of left and right walls 31L and 31R.

According to the configuration of such a modification, a rigidity of the protective member 30 can be further improved, and the protection performance for the arranged component 40 can be improved.

In the configurations of the present embodiment and the modification, the coupling portion 32 of the protective member 30 preferably overlaps the cross member 6 when viewed in the vehicle width direction.

According to such a configuration, for example, when the left wall 31L receives a collision load transmitted from the left cross member 6L, the collision load is favorably transmitted from the coupling portion 32 to the right cross member 6R. Therefore, the protection performance for the arranged component 40 can be further improved.

As described above, the protective member 30 is implemented by the frame member 22 of the battery case 12 and is made of the aluminum extruded material having a high rigidity. Therefore, the protection performance for the arranged component 40 can be improved.

Although one embodiment of the present invention has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the above-described embodiment, the predetermined component (for example, the arranged component 40) disposed between the pair of left and right cross members 6L and 6R is disposed between the battery 11 accommodated in the front-side accommodation space 24 and the battery 11 accommodated in the rear-side accommodation space 25, but the predetermined component is not limited thereto. For example, the predetermined component (for example, the arranged component 40) disposed between the pair of left and right cross members 6L and 6R may be disposed between the battery 11 accommodated in the battery case 12 and a drive source (a motor, a power conversion device, or the like) or a charger disposed behind and/or in front of the battery pack 10.

In the present specification, at least the following matters are described. Although corresponding constituent elements or the like in the above-described embodiment are shown in parentheses, the invention is not limited thereto.
(1) A vehicle lower structure including:
a vehicle body (vehicle body 1); and
a battery pack (battery pack 10) attached to a lower portion of the vehicle body, in which
the battery pack includes
   a battery case (battery case 12),
   a battery (battery 11) accommodated in the battery case, and
   a predetermined component (arranged component 40) accommodated in the battery case and disposed between a pair of left and right cross members (pair of left and right cross members 6L and 6R) extending in a vehicle width direction,
at least a part of the predetermined component overlaps the cross members when viewed in the vehicle width direction, and
the battery pack further includes a protective member (protective member 30) disposed between the cross members and the predetermined component in the vehicle width direction.

According to (1), since the battery pack has a structure in which the predetermined component is disposed between the pair of left and right cross members, a height dimension of the vehicle lower structure can be reduced, and as a result, an overall height of the vehicle can be reduced. Further, in such a structure, since the protective member is disposed between the cross members and the predetermined component, when a collision load is received by the cross members due to a vehicle side collision or the like, the protective member can receive the collision load and the predetermined component can be appropriately protected.
(2) The vehicle lower structure according to (1), in which
the vehicle body includes a tunnel portion (center tunnel 4) disposed between the pair of left and right cross members, and
the tunnel portion covers the predetermined component and the protective member from above and at least a part thereof overlaps the cross members when viewed in the vehicle width direction.

According to (2), when a collision load is received by the cross members due to a vehicle side collision or the like, the collision load is received by the tunnel portion before the protective member receives the collision load transmitted by the cross member, and thus protection performance for the predetermined component can be improved.
(3) The vehicle lower structure according to (2), in which
the tunnel portion is provided with a deformable portion (deformable portion 4a) that deforms more easily than the protective member when a load is received by the cross members.

According to (3), since the tunnel portion can be deformed to absorb collision energy before the protective member receives the collision load, the protection performance for the predetermined component can be further improved.
(4) The vehicle lower structure according to any one of (1) to (3), in which
the protective member is spaced apart from the predetermined component in the vehicle width direction.

According to (4), when a load is transmitted from the cross members to the protective member due to a vehicle collision or the like, an influence of the protective member on the predetermined component can be reduced.
(5) The vehicle lower structure according to any one of (1) to (4), in which
the protective member includes
   a pair of left and right walls (pair of left and right walls 31L and 31R) disposed between the pair of left and right cross members and the predetermined component in the vehicle width direction, and
   a coupling portion (coupling portion 32) that couples the pair of left and right walls.

According to (5), since the protective member includes the pair of left and right walls and the coupling portion that couples the walls, when the wall of the protective member receives a collision load transmitted from one cross member, the collision load can be transmitted to the other cross member via the coupling portion. Therefore, the protection performance for the predetermined component can be improved.
(6) The vehicle lower structure according to (5), in which
the pair of left and right walls and the coupling portion define and form a space that is open upward or downward, and
the predetermined component is disposed in the space.

According to (6), it is easy to dispose the predetermined component into the space defined and formed in the protective member, and thus assemblability of the battery pack is improved.
(7) The vehicle lower structure according to (5), in which
the pair of left and right walls and the coupling portion define and form a space constituting a closed cross section, and
the predetermined component is disposed in the space.

According to (7), since the predetermined component is disposed in the closed cross section space defined and formed in the protective member, it is possible to improve the protection performance for the predetermined component.
(8) The vehicle lower structure according to any one of (5) to (7), in which
the coupling portion overlaps the cross members when viewed in the vehicle width direction.

According to (8), when a collision load transmitted from one cross member is received by the wall of the protective member, the collision load is favorably transmitted from the coupling portion to the other cross member. Therefore, the protection performance for the predetermined component can be further improved.
(9) The vehicle lower structure according to any one of (1) to (8), in which
the protective member is made of an aluminum extruded material.

According to (9), since the protective member is made of the aluminum extruded material, a rigidity of the protective member can be increased, and thus the protection performance for the predetermined component can be improved.
(10) The vehicle lower structure according to any one of (1) to (9), in which
the battery includes a first battery disposed at a front side in the battery case and a second battery disposed at a rear side in the battery case, and
the predetermined component and the protective member are disposed between the first battery and the second battery.

According to (10), the predetermined component disposed between the batteries (first battery and second battery) disposed in front and rear can be protected by the protective member.

### REFERENCE SIGNS LIST

1: vehicle body
4: center tunnel (tunnel portion)
4a: deformable portion
6L, 6R: pair of left and right cross members
10: battery pack
11: battery
12: battery case
30: protective member
31L, 31R: pair of left and right walls
32: coupling portion
40: arranged component (predetermined component)

What is claimed is:

1. A vehicle lower structure comprising:
a vehicle body; and
a battery pack attached to a lower portion of the vehicle body, wherein
the battery pack includes
a battery case,
a battery accommodated in the battery case, and
a component accommodated in the battery case and disposed between a pair of left and right cross members extending in a vehicle width direction,
at least a part of the component overlaps the cross members when viewed in the vehicle width direction, and
the battery pack further includes a protective member, a part of which is disposed between the left cross member and the component and another part of which is disposed between the right cross member and the component in the vehicle width direction.

2. The vehicle lower structure according to claim 1, wherein
the vehicle body includes a tunnel portion disposed between the pair of left and right cross members, and
the tunnel portion covers the component and the protective member from above and at least a part of the tunnel portion overlaps the cross members when viewed in the vehicle width direction.

3. The vehicle lower structure according to claim 2, wherein
the tunnel portion is provided with a deformable portion that deforms more easily than the protective member when a load is received by the cross members.

4. The vehicle lower structure according to claim 1, wherein
the protective member is spaced apart from the component in the vehicle width direction.

5. The vehicle lower structure according to claim 2, wherein
the protective member is spaced apart from the component in the vehicle width direction.

6. The vehicle lower structure according to claim 3, wherein
the protective member is spaced apart from the component in the vehicle width direction.

7. The vehicle lower structure according to claim 1, wherein
the protective member includes
a pair of left and right walls, in which the left wall is disposed between the left cross member and the component and the right wall is disposed between the right cross member and the component in the vehicle width direction, and
a coupling portion that couples the pair of left and right walls.

8. The vehicle lower structure according to claim 2, wherein
the protective member includes
a pair of left and right walls, in which the left wall is disposed between the left cross member and the component and the right wall is disposed between the right cross member and the component in the vehicle width direction, and
a coupling portion that couples the pair of left and right walls.

9. The vehicle lower structure according to claim 3, wherein
the protective member includes
a pair of left and right walls, in which the left wall is disposed between the left cross member and the component and the right wall is disposed between the right cross member and the component in the vehicle width direction, and
a coupling portion that couples the pair of left and right walls.

10. The vehicle lower structure according to claim 7, wherein
the pair of left and right walls and the coupling portion define a space that is open upward or downward, and
the component is disposed in the space.

11. The vehicle lower structure according to claim 8, wherein
the pair of left and right walls and the coupling portion define a space that is open upward or downward, and
the component is disposed in the space.

12. The vehicle lower structure according to claim 9, wherein
the pair of left and right walls and the coupling portion define a space that is open upward or downward, and
the component is disposed in the space.

13. The vehicle lower structure according to claim 7, wherein
the pair of left and right walls and the coupling portion define a space constituting a closed cross section, and
the component is disposed in the space.

14. The vehicle lower structure according to claim 8, wherein
the pair of left and right walls and the coupling portion define a space constituting a closed cross section, and
the component is disposed in the space.

15. The vehicle lower structure according to claim 9, wherein
the pair of left and right walls and the coupling portion define a space constituting a closed cross section, and
the component is disposed in the space.

16. The vehicle lower structure according to claim 7, wherein
the coupling portion overlaps the cross members when viewed in the vehicle width direction.

17. The vehicle lower structure according to claim 8, wherein
the coupling portion overlaps the cross members when viewed in the vehicle width direction.

18. The vehicle lower structure according to claim 9, wherein
the coupling portion overlaps the cross members when viewed in the vehicle width direction.

19. The vehicle lower structure according to claim 1, wherein
the protective member is made from an aluminum extruded material.

20. The vehicle lower structure according to any one of claim 1, wherein
the battery includes a first battery disposed at a front side in the battery case and a second battery disposed at a rear side in the battery case, and
the component and the protective member are disposed between the first battery and the second battery.
